(19) United States
(12) Patent Application Publication
(10) Pub. No.: US 2010/0194730 A1
(43) Pub. Date: Aug. 5, 2010

(54) Display driving semiconductor device

(75) Inventor: Ryo Takeuchi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/654,247

(22) Filed: Dec. 15, 2009

(30) Foreign Application Priority Data
Jan. 30, 2009 (JP) 20412/2009

(51) Int. Cl. G06F 3/038

(52) U.S. Cl. 345/211

(57) ABSTRACT

In order to decrease the length of a semiconductor element in a long side direction taking into consideration a disposition of electrodes and circuits, center portions (30a-3, 30a-4, and 30a-5) of a long side portion (30a) of the semiconductor element (30) include the plurality of display input electrodes (34) arranged in the long side direction (X). A center portion (30b-3) of a long side portion (30b) includes the plurality of power supply input electrodes (41) arranged in the long side direction (X). The center portions (30a-3, 30a-4, and 30a-5) of the long side portion (30a) further include space or an electrode for routing the conductor wiring (51) from the substrate (32) to the plurality of power supply input electrodes (41).

### BACKGROUND OF THE INVENTION

1. Field of the Invention

The present invention relates to a display driving semiconductor device provided between a substrate and a display portion.

2. Description of the Related Art

FIG. 1 illustrates a structure of a display device to which a typical display driving semiconductor device 11 is applied. The display device includes a substrate 12, a display portion 13, and the display driving semiconductor device 11 provided between the substrate 12 and the display portion 13.

A display controller (not shown) and a power supply circuit (not shown) are mounted on the substrate 12. The display controller outputs a clock signal, a control signal, and display data. The power supply circuit supplies power to the display driving semiconductor device 11.

The display driving semiconductor device 11 includes a semiconductor element 10. A plurality of input electrodes 14, a plurality of output electrodes 15, and a plurality of dummy electrodes 20 are mounted on the semiconductor element 10. Each of the plurality of input electrodes 14 is connected to the substrate 12 via conductor wiring 18, while each of the plurality of output electrodes 15 is connected to the display portion 13 via conductor wiring 19.

The semiconductor element 10 is provided on a base and includes a plurality of output circuits 16. A plurality of display input electrodes (not shown and hereinafter, referred to as display input electrodes 14′) to which display data is supplied, of the plurality of input electrodes 14 are connected to inputs of the plurality of output circuits 16, respectively. The plurality of output electrodes 15 are connected to outputs of the plurality of output circuits 16, respectively. A plurality of power supply input electrodes (not shown and hereinafter, referred to as power supply input electrodes 14″) to which power is supplied, of the plurality of input electrodes 14 are connected to power supplies of the plurality of output circuits 16, respectively.

Each of the plurality of output circuits 16 includes a logic circuit, a D/A converter circuit, an output amplifier circuit, and the like. Each of the plurality of output circuits 16 outputs after current amplification an output gradation voltage corresponding to the display data, of a plurality of gradation voltages.

When the conductor wiring 18 and the conductor wiring 19 are routed around the semiconductor element 10, it is preferable that the input electrodes 14 be disposed on the side of the substrate 12 with respect to the semiconductor element 10 and that the output electrodes 15 be disposed on the side of the display portion 13 with respect to the semiconductor element 10. Further, because the display driving semiconductor device 11 is mounted on a frame of the display portion 13, the need for making narrower the frame and the like make it necessary to form a plane portion of the semiconductor element 10 in the shape of a slim rectangle. Further, a trend toward more outputs makes it necessary to dispose the output electrodes 15 also on the side of the substrate 12, which in turn makes it necessary to dispose the output circuits 16 accordingly. Therefore, it is necessary to route a great number of the conductor wiring 19 from the output electrodes 15 disposed on the semiconductor element 10 on the side of the substrate 12 toward the side of the display portion 13, which is described in the following.

FIG. 2 illustrates the plane portion of the semiconductor element 10. As described above, the plane portion of the semiconductor element 10 is in the shape of a rectangle. The substrate 12 and the display portion 13 are provided in a long side direction X away from first and second long side portions (hereinafter, referred to as long side portions 10a and 10b), respectively, of two long side portions of the plane portion so as to be in parallel with each other.

First and second groups of output electrodes of the plurality of output electrodes 15 (hereinafter, referred to as groups of output electrodes 15-1 and 15-2) are arranged in first and second portions of the long side portion 10a (hereinafter, referred to as portions 10a-1 and 10a-2), respectively, in the long side direction X.

Third and fourth groups of output electrodes of the plurality of output electrodes 15 (hereinafter, referred to as groups of output electrodes 15-3 and 15-4) are arranged in first and second portions of the long side portion 10b (hereinafter, referred to as portions 10b-1 and 10b-2), respectively, in the long side direction X.

The plurality of input electrodes 14 (plurality of display input electrodes 14′ and plurality of power supply input electrodes 14″) are arranged in a center portion 10a-3 between the portions 10a-1 and 10a-2 of the long side portion 10a in the long side direction X.

The plurality of dummy electrodes 20 are arranged in a center portion 10b-3 between the portions 10b-1 and 10b-2 of the long side portion 10b in the long side direction X.

A first group of output circuits (hereinafter, referred to as a group of output circuits 16-1) of the plurality of output circuits 16 are arranged in a region of the plane portion of the semiconductor element 10 between the group of output electrodes 15-1 and the group of output electrodes 15-3 in the long side direction X. Outputs of the group of output circuits 16-1 are connected to the group of output electrodes 15-1.

A second group of output circuits (hereinafter, referred to as a group of output circuits 16-2) of the plurality of output circuits 16 are arranged in a region of the plane portion between the group of output electrodes 15-2 and the group of output electrodes 15-4 in the long side direction X. Outputs of the group of output circuits 16-2 are connected to the group of output electrodes 15-2.

A third group of output circuits (hereinafter, referred to as a group of output circuits 16-3) of the plurality of output circuits 16 are arranged in a region of the plane portion between the group of output circuits 16-1 and the group of output electrodes 15-3 in the long side direction X. Outputs of the group of output circuits 16-3 are connected to the group of output electrodes 15-3.

A fourth group of output circuits (hereinafter, referred to as a group of output circuits 16-4) of the plurality of output circuits 16 are arranged in a region of the plane portion between the group of output circuits 16-2 and the group of output electrodes 15-4 in the long side direction X. Outputs of the group of output circuits 16-4 are connected to the group of output electrodes 15-4.

The power supplies of the plurality of output circuits 16 are provided in a region of the plane portion between the plurality of input electrodes 14 and the plurality of dummy electrodes 20. As described above, the power supplies of the plurality of output circuits 16 are connected to the plurality of power supply input electrodes 14″, respectively, of the plurality of input electrodes 14, and the inputs of the plurality of output circuits 16 are connected to the plurality of display input electrodes 14′, respectively, of the plurality of input electrodes 14.

As described above, the input electrodes 14 (the display input electrodes 14′ and the power supply input electrodes 14″) are disposed in the center portion 10a-3 of the long side portion 10a of the semiconductor element 10. Wiring on the base of the display driving semiconductor device 11 is single layer wiring in view of the cost and base flexibility, and, thus, it is not possible to route the wiring over another wiring. Therefore, it is not possible to dispose the conductor wiring 18 to be connected to the input electrodes 14 in the region in which the conductor wiring 19 to be connected to the groups of output electrodes 15-1 and 15-2 exists. Further, taking into consideration the left-right symmetry of the chip in order to make uniform the output characteristics, the input electrodes 14 are inevitably disposed in the region described above.

Further, as described above, the output electrodes 15 are disposed in the neighborhood of the input electrodes 14 (strictly speaking, in the portions 10a-1 and 10a-2 of the long side portion 10a and in the portions 10b-1 and 10b-2 of the long side portion 10b). In order to prevent display unevenness, wiring resistances between the output electrodes 15 and the output circuits 16 are made to be the same with regard to all the outputs. In this case, it is necessary to make all the respective distances between the output electrodes 15 and the output circuits 16 the same and make the distances between the output electrodes 15 the same and the distance between the output circuits 16 the same, which is the reason that the output electrodes 15 are disposed as described above.

For the reason described above, it is not necessary to dispose electrodes in the center portion 10b-3 of the long side portion 10b. However, in the base of the display driving semiconductor device 11 and the semiconductor element 10, all the electrodes of the semiconductor element 10 are connected at one time by thermocompression bonding or the like to the wiring on the base of the display driving semiconductor device 11, and hence it is necessary to dispose the electrodes so as to be left-right symmetrical and top-bottom symmetrical such that pressure applied in the thermocompression bonding to the electrodes is as even as possible. Therefore, the dummy electrodes 20 are disposed in the center portion 10b-3 of the long side portion 10b in the same way as the electrodes are disposed in the opposed center portion 10a-3 of the long side portion 10a.

However, in recent years, the length of the semiconductor element 10 in the long side direction has been increased in the trend toward more outputs. Therefore, space for the routing of the conductor wiring on the base decreases and design of the conductor wiring becomes more difficult. Or, if the routing is attempted, it is necessary to increase the width of the base, which increases the cost. Therefore, it is desirable to decrease the length of the semiconductor element 10 in the long side direction.

Here, examples of routing the conductor wiring to the outside of the semiconductor element are described with reference to FIGS. 3 and 4 (FIGS. 1 and 4 in Japanese Patent Application Laid-open No. 2006-332544).

In the example illustrated in FIG. 3, the plane portion of a semiconductor element 1 provided on a base 3 is in the shape of a rectangle. Electrodes 5 are provided in a first long side portion of two long side portions of the semiconductor element 1, and electrodes 5a are provided in a second long side portion of the two long side portions of the semiconductor element 1. Electrodes 7 are provided in a first short side portion of two short side portions of the semiconductor element 1. Conductor wiring 4a is connected to the electrodes 5a, and is routed to the outside of the semiconductor element 1 via the electrodes 7 as conductor wiring 6.

In the example illustrated in FIG. 4, the plane portion of the semiconductor element 1 provided on the base 3 is in the shape of a rectangle. The electrodes 5 are provided in the first long side portion of the two long side portions of the semiconductor element 1. Dummy electrodes 5′ are provided in a center portion of a second long side portion of the two long side portions of the semiconductor element 1. Electrodes 5e are provided in regions other than the center portion of the second long side portion. Conductor wiring 4f is connected to the electrodes 5e, and is routed to the outside of the semiconductor element 1 via the electrodes 5.

In the example illustrated in FIG. 3, the conductor wiring 4a is routed around from the second long side portion through the first short side portion to the outside of the semiconductor element 1. However, the example illustrated in FIG. 3 does not consider the disposition of the electrodes (input electrodes 14 and output electrodes 15) and of the circuits (output circuits 16). Therefore, this is not applicable to the conventional display driving semiconductor device 11 (FIGS. 1 and 2).

In the example illustrated in FIG. 4, the conductor wiring 4f is routed from the second long side portion through the first long side portion to the outside of the semiconductor element 1. However, the example illustrated in FIG. 4 does not consider decreasing the length of the semiconductor element in the long side direction. Therefore, the dummy electrodes 5′ remain in the second long side portion, and therefore this is not applicable to the conventional display driving semiconductor device 11 (FIGS. 1 and 2).

### SUMMARY OF THE INVENTION

Means for solving the problem is described in the following with reference numerals in parentheses which are used in DETAILED DESCRIPTION OF THE INVENTION. The reference numerals are added only for clarifying correspondences between claims of the present invention and DETAILED DESCRIPTION OF THE INVENTION, and should by no means be used in interpreting the technical scope of the present invention as defined by the claims.

According to an aspect of the present invention, a display driving semiconductor device (31) includes a semiconductor element (30), a plurality of power supply input electrodes (41), a plurality of display input electrodes (34), and a plurality of output electrodes (35). The semiconductor element (30) produces a plurality of gradation voltages, and outputs, after current amplification, an output gradation voltage corresponding to display data among the plurality of gradation voltages. A plane portion of the semiconductor element (30) is in a shape of a rectangle. A substrate (32) and a display portion (33) are provided in a long side direction (X) away from first and second long side portions (30a and 30b) of two long side portions of the plane portion so as to be in parallel with each other, respectively. The plurality of power supply input electrodes (41) supply to the semiconductor element (30) power which is output from the substrate (32) via first conductor wiring (51). The plurality of display input electrodes (34) supply to the semiconductor element (30) the display data which is output from the substrate (32) via second conductor wiring (52). The plurality of output electrodes (35) supply via third conductor wiring (53) to the display portion (33) the output gradation voltage which is output from the semiconductor element (30) after current amplification. Center portions (30a-3, 30a-4, and 30a-5) of the first long side portion (30a) include the plurality of display input electrodes (34) arranged in the long side direction (X). A center portion (30b-3) of the second long side portion (30b) includes the plurality of power supply input electrodes (41) arranged in the long side direction (X). The center portions (30a-3, 30a-4, and 30a-5) of the first long side portion (30a) further include space (40) or an electrode (40) for routing the first conductor wiring (51) from the substrate (32) to the plurality of power supply input electrodes (41).

In the display driving semiconductor device (31) according to the present invention, the display input electrodes (34) are disposed in the center portions (30a-3, 30a-4, and 30a-5) of the first long side portion (30a) of the semiconductor element (30), and the power supply input electrodes (41) are disposed in the center portion (30b-3) of the second long side portion (30b) of the semiconductor element (30). More specifically, according to the present invention, dummy electrodes are not required to be disposed in the semiconductor element (30). As described above, in the display driving semiconductor device (31) according to the present invention, the length of the semiconductor element (30) in the long side direction may be decreased taking into consideration the disposition of the electrodes and circuits.

### BRIEF DESCRIPTION OF THE DRAWINGS

In the accompanying drawings:

FIG. 1 illustrates a structure of a display device to which a typical display driving semiconductor device is applied;

FIG. 2 illustrates a plane portion of a semiconductor element in the typical display driving semiconductor device;

FIG. 3 illustrates a plane portion of a semiconductor element illustrated in FIG. 1 of Japanese Patent Application Laid-open No. 2006-332544;

FIG. 4 illustrates a plane portion of a semiconductor element illustrated in FIG. 4 of Japanese Patent Application Laid-open No. 2006-332544;

FIG. 5 illustrates a structure of a display device to which a display driving semiconductor device according to first and second embodiments of the present invention is applied;

FIG. 6 illustrates a plane portion of a semiconductor element 30 in the display driving semiconductor device according to the first embodiment of the present invention;

FIG. 7 is an explanatory view of a problem which arises when the present invention is not applied;

FIG. 8 is an explanatory view of an effect of the present invention in the display driving semiconductor device according to the first embodiment of the present invention;

FIG. 9 illustrates a plane portion of a semiconductor element in the display driving semiconductor device according to the second embodiment of the present invention; and

FIG. 10 is an explanatory view of an effect of the present invention in the display driving semiconductor device according to the second embodiment of the present invention.

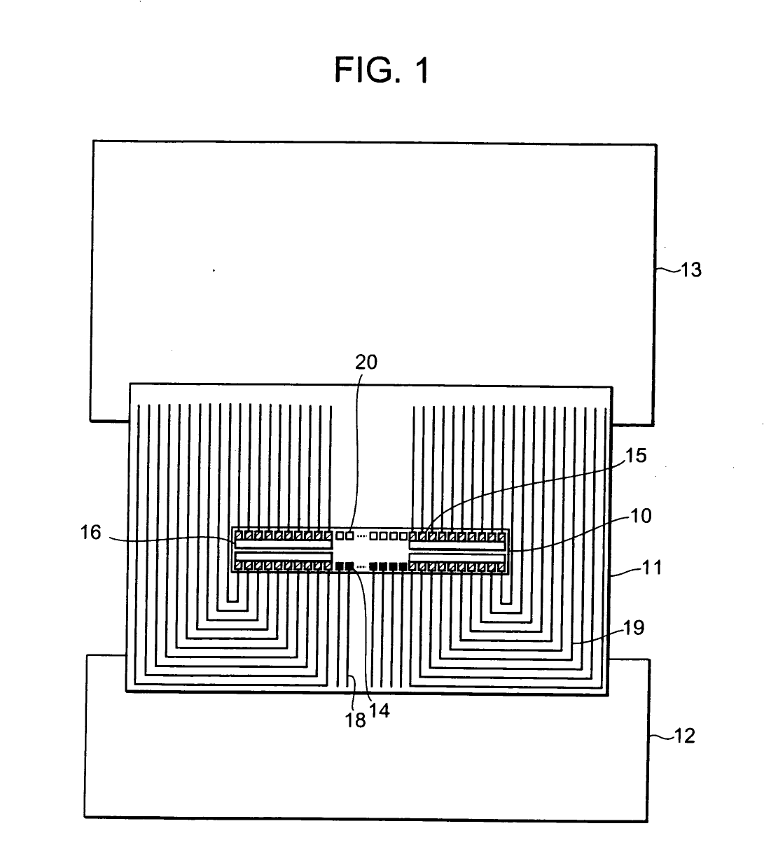

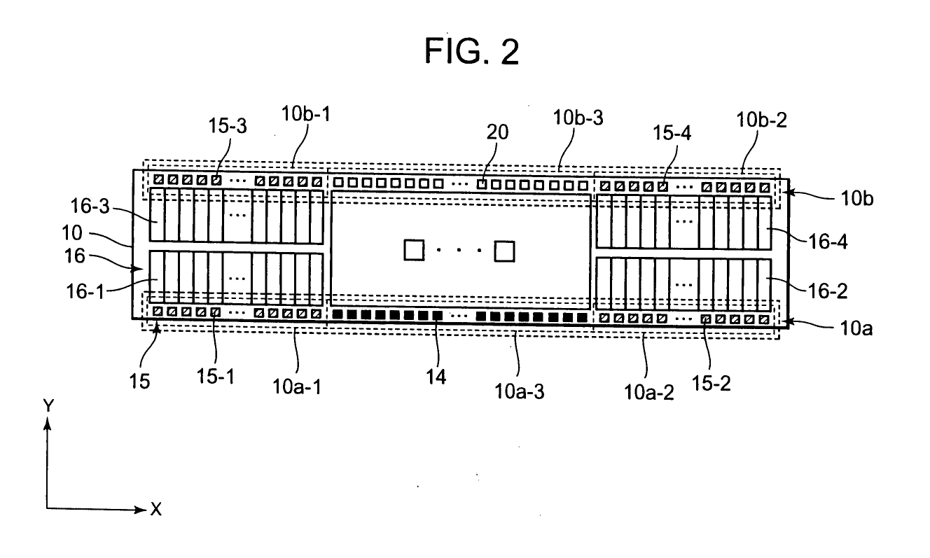

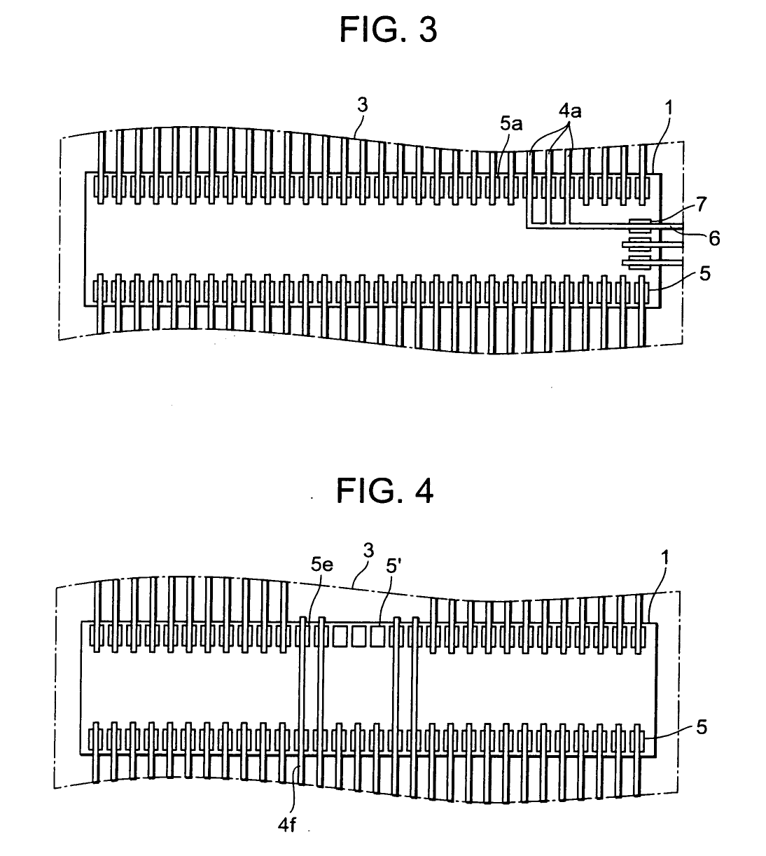

### DETAILED DESCRIPTION OF THE PREFERRED EMBODIMENTS

Display driving semiconductor devices according to embodiments of the present invention are now described in detail in the following with reference to the attached drawings.

### First Embodiment

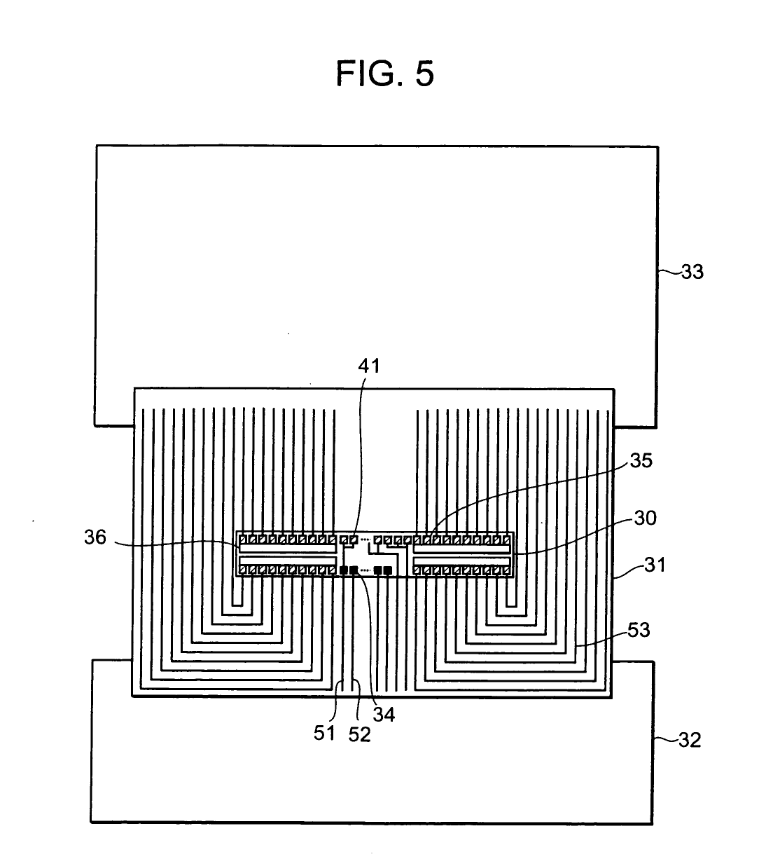

FIG. 5 illustrates a structure of a display device to which a display driving semiconductor device 31 according to a first embodiment of the present invention is applied. The display device includes a substrate 32, a display portion 33, and a display driving semiconductor device 31 provided between the substrate 32 and the display portion 33.

A display controller (not shown) and a power supply circuit (not shown) are mounted on the substrate 32. The display controller outputs a clock signal, a control signal, and display data. The power supply circuit supplies power to the display driving semiconductor device 31.

The display driving semiconductor device 31 includes a semiconductor element 30. A plurality of power supply input electrodes 41, a plurality of display input electrodes 34, and a plurality of output electrodes 35 are mounted on the semiconductor element 30. Each of the plurality of power supply input electrodes 41 is connected to the substrate 32 via first conductor wiring (hereinafter, referred to as conductor wiring 51) and supplies to the semiconductor element 30 power which is output from the substrate 32 via the conductor wiring 51. Each of the plurality of display input electrodes 34 is connected to the substrate 32 via second conductor wiring (hereinafter, referred to as conductor wiring 52) and supplies to the semiconductor element 30 display data which is output from the substrate 32 via the conductor wiring 52. Each of the plurality of output electrodes 35 supplies via third conductor wiring (hereinafter, referred to as conductor wiring 53) to the display portion 33 an output gradation voltage (to be described later) which is output from the semiconductor element 30.

The semiconductor element 30 is provided on a base and includes a plurality of output circuits 36. The plurality of display input electrodes 34 are connected to inputs of the plurality of output circuits 36, respectively. The plurality of output electrodes 35 are connected to outputs of the plurality of output circuits 36, respectively. The plurality of power supply input electrodes 41 are connected to power supplies of the plurality of output circuits 36, respectively.

Each of the plurality of output circuits 36 includes a logic circuit, a D/A converter circuit, an output amplifier circuit, and the like. Each of the plurality of output circuits 36 outputs after current amplification an output gradation voltage corresponding to the display data, of a plurality of gradation voltages.

When the conductor wiring 51 and the conductor wiring 52 are routed around the semiconductor element 30, the power supply input electrodes 41 and the plurality of display input electrodes 34 are disposed on the side of the display portion 33 and on the side of the substrate 32, respectively, with respect to the semiconductor element 30. Further, because the display driving semiconductor device 31 is mounted on a frame of the display portion 33, the need for making narrower the frame and the like make it necessary to form a plane portion of the semiconductor element 30 in the shape of a slim rectangle. Further, the trend toward more outputs makes it necessary to dispose the output electrodes 35 both on the side of the substrate 32 and on the side of the display portion 33 with respect to the semiconductor element 30, which in turn makes it necessary to dispose the output circuits 36 accordingly. Therefore, when the conductor wiring 53 is routed around the semiconductor element 30, it is necessary to route a great number of the conductor wiring 53 from the output electrodes 35 disposed on the semiconductor element 30 on the side of the substrate 32 toward the side of the display portion 33, which is described in the following.

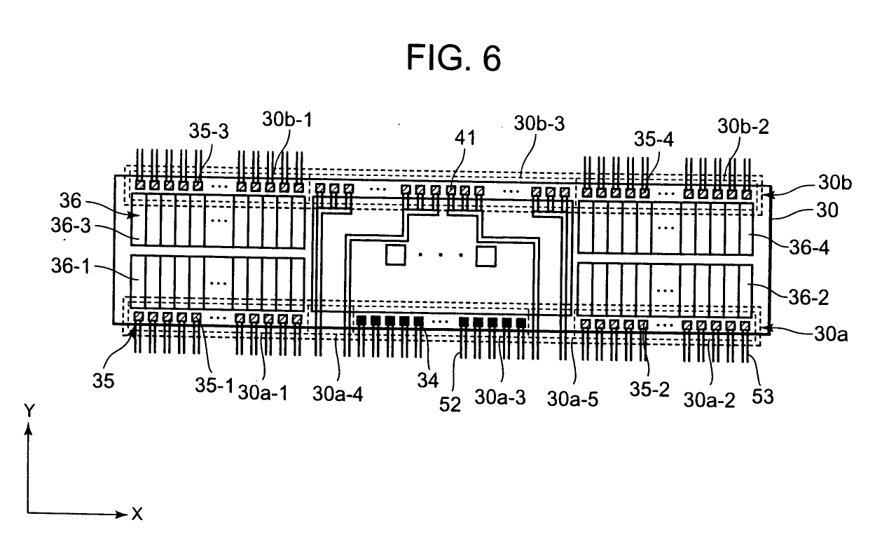

FIG. 6 illustrates the plane portion of the semiconductor element 30. As described above, the plane portion of the semiconductor element 30 is in the shape of a rectangle. The substrate 32 and the display portion 33 are provided in a long side direction X away from first and second long side portions (hereinafter, referred to as long side portions 30a and 30b), respectively, of two long side portions of the plane portion so as to be in parallel with each other.

First and second groups of output electrodes of the plurality of output electrodes 35 (hereinafter, referred to as groups of output electrodes 35-1 and 35-2) are arranged in first and second portions of the long side portion 30a (hereinafter, referred to as portions 30a-1 and 30a-2), respectively, in the long side direction X.

Third and fourth groups of output electrodes of the plurality of output electrodes 35 (hereinafter, referred to as groups of output electrodes 35-3 and 35-4) are arranged in first and second portions of the long side portion 30b (hereinafter, referred to as portions 30b-1 and 30b-2), respectively, in the long side direction X.

The plurality of power supply input electrodes 41 are arranged in a center portion 30b-3 between the portions 30b-1 and 30b-2 of the long side portion 30b in the long side direction X.

The plurality of display input electrodes 34 are arranged in center portions 30a-3, 30a-4, and 30a-5 between the portions 30a-1 and 30a-2 of the long side portion 30a in the long side direction X. Spaces (or electrodes) for routing the conductor wiring 51 which extends from the substrate 32 to the plurality of power supply input electrodes 41 in a short side direction Y are further provided in the center portions 30a-3, 30a-4, and 30a-5.

For example, the plurality of display input electrodes 34 are arranged in a third portion (hereinafter, referred to as portion 30a-3) between the portions 30a-1 and 30a-2 of the long side portion 30a in the long side direction X. The above-mentioned spaces (or electrodes) are arranged in the portion 30a-4 between the portions 30a-1 and 30a-3 and in the portion 30a-5 between the portions 30a-3 and 30a-2 of the long side portion 30a in the long side direction X.

A first group of output circuits (hereinafter, referred to as a group of output circuits 36-1) of the plurality of output circuits 36 are arranged in a region of the plane portion of the semiconductor element 30 between the group of output electrodes 35-1 and the group of output electrodes 35-3 in the long side direction X. Outputs of the group of output circuits 36-1 are connected to the group of output electrodes 35-1.

A second group of output circuits (hereinafter, referred to as a group of output circuits 36-2) of the plurality of output circuits 36 are arranged in a region of the plane portion between the group of output electrodes 35-2 and the group of output electrodes 35-4 in the long side direction X. Outputs of the group of output circuits 36-2 are connected to the group of output electrodes 35-2.

A third group of output circuits (hereinafter, referred to as a group of output circuits 36-3) of the plurality of output circuits 36 are arranged in a region of the plane portion between the group of output circuits 36-1 and the group of output electrodes 35-3 in the long side direction X. Outputs of the group of output circuits 36-3 are connected to the group of output electrodes 35-3.

A fourth group of output circuits (hereinafter, referred to as a group of output circuits 36-4) of the plurality of output circuits 36 are arranged in a region of the plane portion between the group of output circuits 36-2 and the group of output electrodes 35-4 in the long side direction X. Outputs of the group of output circuits 36-4 are connected to the group of output electrodes 35-4.

The power supplies of the plurality of output circuits 36 are provided in a region of the plane portion between the plurality of display input electrodes 34 and the above-mentioned spaces (or electrodes), and the plurality of power supply input electrodes 41. As described above, the power supplies of the plurality of output circuits 36 are connected to the plurality of power supply input electrodes 41, respectively, and the inputs of the plurality of output circuits 36 are connected to the plurality of display input electrodes 34, respectively.

As described above, the power supply input electrodes 41 are disposed in the center portion 30b-3 of the long side portion 30b of the semiconductor element 30. Wiring on the base of the display driving semiconductor device 31 is single layer wiring in view of the cost and base flexibility, and thus, it is not possible to route the wiring over another wiring. Therefore, it is not possible to dispose the conductor wiring 52 to be connected to the power supply input electrodes 41 in the region in which the conductor wiring 53 to be connected to the groups of output electrodes 35-1 and 35-2 exists. Further, taking into consideration the left-right symmetry of the chip in order to make uniform the output characteristics, the power supply input electrodes 41 are inevitably disposed in the region described above.

Further, as described above, the output electrodes 35 are disposed in the neighborhood (strictly speaking, in the portions 30a-1 and 30a-2 of the long side portion 30a and in the portions 30b-1 and 30b-2 of the long side portion 30b) of the input electrodes (display input electrodes 34 and power supply input electrodes 41). In order to prevent display unevenness, wiring resistances between the output electrodes 35 and the output circuits 36 are made to be the same with regard to all the outputs. In this case, it is necessary to make all the respective distances between the output electrodes 35 and the output circuits 36 the same and make the distances between the output electrodes 35 the same and the distances between the output circuits 36 the same, which is the reason that the output electrodes 35 are disposed as described above.

Further, in the display driving semiconductor device 31 according to the first embodiment of the present invention, as described above, the display input electrodes 34 are disposed in the center portion 30a-3 of the long side portion 30a of the semiconductor element 30, while the power supply input electrodes 41 are disposed in the center portion 30b-3 of the long side portion 30b of the semiconductor element 30. More specifically, according to the present invention, dummy electrodes do not need to be disposed in the semiconductor element 30. As described above, in the display driving semiconductor device 31 according to the first embodiment of the present invention, the length of the semiconductor element 30 in the long side direction may be decreased taking into consideration the disposition of the electrodes (display input electrodes 34, power supply input electrodes 41, and output electrodes 35) and the circuits (output circuits 36).

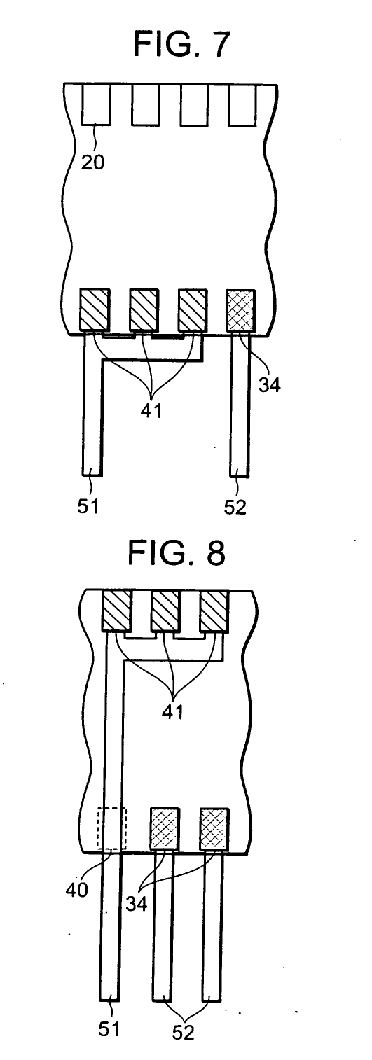

Because the power supply input electrodes 41 are required to be resistant to high voltage, it is necessary to use a protection element which is larger than a protection element (not shown) used for the display input electrodes 34. Further, in order to make small the connection resistance between the power supply input electrodes 41 and the conductor wiring 51, the area of a portion which connects the power supply input electrodes 41 and the conductor wiring 51 is required to be large. Therefore, each of the power supply input electrodes 41 has an area of a portion which connects each of the power supply input electrodes 41 and the conductor wiring, which is larger than an area of a corresponding portion of the plurality of display input electrodes 34. Alternatively, each of the power supply input electrodes 41 includes a plurality of (two or more) electrodes (hereinafter, referred to as electrodes resistant to high voltage) each having a dimension which is the same as a dimension of each of the plurality of display input electrodes 34. Therefore, the number of the electrodes resistant to high voltage as the power supply input electrodes 41 greatly affects the length of the long side portion. For example, when the power supply input electrodes 41 and the display input electrodes 34 are disposed in the center portion 30a-3 of the long side portion 30a as illustrated in FIG. 7, the length of the semiconductor element 30 in the long side direction is increased.

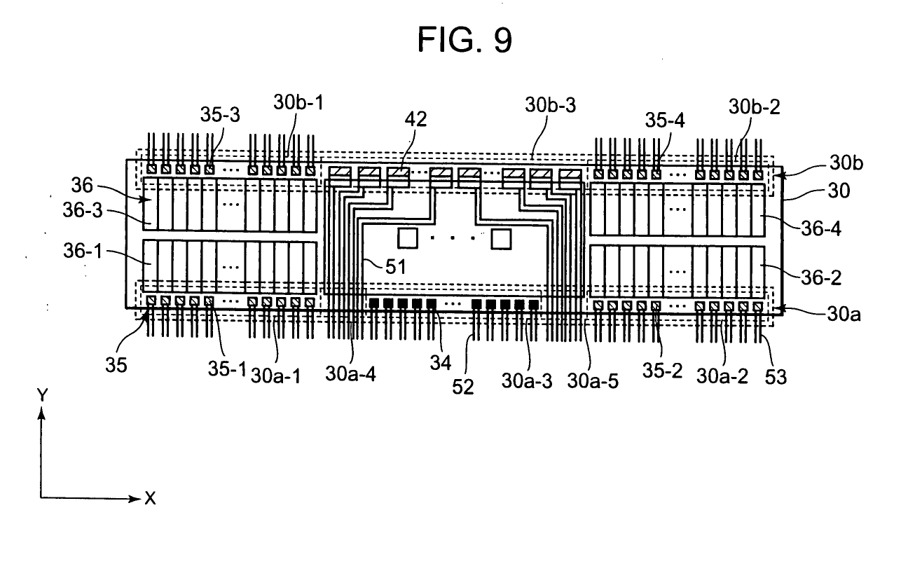

In the display driving semiconductor device 31 according to the first embodiment of the present invention, as described above, the display input electrodes 34 are disposed in the center portion 30a-3 of the long side portion 30a of the semiconductor element 30, and the power supply input electrodes 41 are disposed in the center portion 30b-3 of the long side portion 30b of the semiconductor element 30. For example, as illustrated in FIG. 8, when the number of the electrodes resistant to high voltage as the power supply input electrodes 41 which are disposed in the center portion 30b-3 is three with respect to two display input electrodes 34 which are disposed in the center portion 30a-3, a space 40 (or electrode 40) necessary in the center portion 30a-3 for routing the conductor wiring 51 is only for one electrode. The space 40 (or electrode 40) corresponds to the above-described spaces (or electrodes). As described above, in the display driving semiconductor device 31 according to the first embodiment of the present invention, by disposing, instead of dummy electrodes, the power supply input electrodes 41 in the center portion 30b-3 of the long side portion 30b of the semiconductor element 30, resistance to high voltage is realized, and at the same time, the length of the semiconductor element 30 in the long side direction may be decreased. It is to be noted that, when an electrode is disposed in the space 40, because the object is to keep the balance when the electrodes and the wiring on the base are connected by thermocompression bonding or the like, the electrode disposed in the space does not necessarily need to be connected to an internal element of the semiconductor element 30.

### Second Embodiment

In describing a display driving semiconductor device 31 according to a second embodiment of the present invention, description of parts similar to those of the first embodiment is omitted.

FIG. 9 illustrates a plane portion of a semiconductor element 30. In the second embodiment, instead of the plurality of power supply input electrodes 41, a plurality of power supply input electrodes 42 are mounted on the semiconductor element 30. As each of the plurality of power supply input electrodes 42, an electrode having the dimension which is larger than the dimension of each of the plurality of display input electrodes 34 is used.

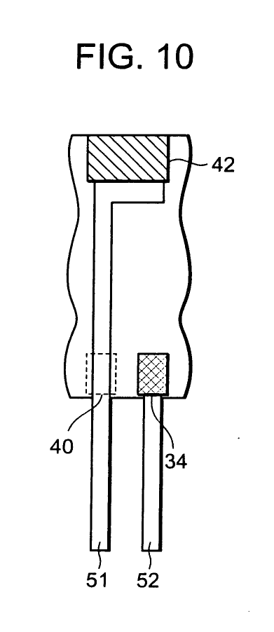

The effect of the present invention in the second embodiment is the same as that in the first embodiment. For example, as illustrated in FIG. 10, when the dimension of each of the power supply input electrodes 42 which are disposed in the center portion 30b-3 corresponds to the dimension of two display input electrodes 34 which are disposed in the center portion 30a-3, the space 40 (or electrode 40) necessary in the center portion 30a-3 for routing the conductor wiring 51 is only for one electrode.

What is claimed is:

1. A display driving semiconductor device, comprising:
a semiconductor element for producing a plurality of gradation voltages and outputting, among the plurality of gradation voltages, an output gradation voltage corresponding to display data, the semiconductor element including a plane portion in a shape of a rectangle, in which a substrate and a display portion are provided in along side direction away from a first long side portion and a second long side portion of two long side portions of the plane portion so as to be in parallel with each other, respectively;
a plurality of power supply input electrodes for supplying to the semiconductor element power which is output from the substrate via first conductor wiring;
a plurality of display input electrodes for supplying to the semiconductor element the display data which is output from the substrate via second conductor wiring; and
a plurality of output electrodes for supplying via third conductor wiring to the display portion the output gradation voltage which is output from the semiconductor element, wherein:
a center portion of the first long side portion includes the plurality of display input electrodes arranged in the long side direction;
a center portion of the second long side portion includes the plurality of power supply input electrodes arranged in the long side direction; and
the center portion of the first long side portion further includes one of space and an electrode for routing the first conductor wiring from the substrate to the plurality of power supply input electrodes.

2. A display driving semiconductor device according to claim 1, wherein:
a first portion and a second portion of the first long side portion include a first group of output electrodes and a second group of output electrodes of the plurality of output electrodes arranged in the long side direction, respectively;
a first portion and a second portion of the second long side portion include a third group of output electrodes and a fourth group of output electrodes of the plurality of output electrodes arranged in the long side direction, respectively;
a center portion between the first portion and the second portion of the second long side portion includes the plurality of power supply input electrodes arranged in the long side direction; and
a center portion between the first portion and the second portion of the first long side portion includes the plurality of display input electrodes arranged in the long side direction and the one of the space and the electrode.

3. A display driving semiconductor device according to claim 2, wherein:
the semiconductor element comprises a plurality of output circuits for outputting, among the plurality of gradation voltages, the output gradation voltage corresponding to the display data;
a region of the plane portion between the first group of output electrodes and the third group of output electrodes includes a first group of output circuits of the plurality of output circuits, which have outputs connected to the first group of output electrodes, arranged in the long side direction;
a region of the plane portion between the second group of output electrodes and the fourth group of output electrodes includes a second group of output circuits of the plurality of output circuits, which have outputs connected to the second group of output electrodes, arranged in the long side direction;
a region of the plane portion between the first group of output circuits and the third group of output electrodes includes a third group of output circuits of the plurality of output circuits, which have outputs connected to the third group of output electrodes, arranged in the long side direction; and
a region of the plane portion between the second group of output circuits and the fourth group of output electrodes includes a fourth group of output circuits of the plurality of output circuits, which have outputs connected to the fourth group of output electrodes, arranged in the long side direction.

4. A display driving semiconductor device according to claim 1, wherein each of the plurality of power supply input electrodes has an area of a portion which connects each of the plurality of power supply input electrodes and the first conductor wiring, which is larger than an area of a corresponding portion of each of the plurality of display input electrodes.

5. A display driving semiconductor device according to claim 4, wherein each of the plurality of power supply input electrodes comprises a plurality of electrodes each having a dimension which is the same as a dimension of each of the plurality of display input electrodes.

6. A display driving semiconductor device according to claim 4, wherein each of the plurality of power supply input electrodes comprises an electrode having a dimension which is larger than a dimension of each of the plurality of display input electrodes.

7. A display device, comprising:
a substrate;
a display portion;
a semiconductor element for producing a plurality of gradation voltages and outputting, among the plurality of gradation voltages, an output gradation voltage corresponding to display data, the semiconductor element including a plane portion in a shape of a rectangle, in which the substrate and the display portion are provided in a long side direction away from a first long side portion and a second long side portion of two long side portions of the plane portion so as to be in parallel with each other, respectively;
a plurality of power supply input electrodes for supplying to the semiconductor element power which is output from the substrate via first conductor wiring;
a plurality of display input electrodes for supplying to the semiconductor element the display data which is output from the substrate via second conductor wiring; and
a plurality of output electrodes for supplying via third conductor wiring to the display portion the output gradation voltage which is output from the semiconductor element, wherein:
a center portion of the first long side portion includes the plurality of display input electrodes arranged in the long side direction;
a center portion of the second long side portion includes the plurality of power supply input electrodes arranged in the long side direction; and
the center portion of the first long side portion further includes one of space and an electrode for routing the first conductor wiring from the substrate to the plurality of power supply input electrodes.

8. A display device according to claim 7, wherein:
a first portion and a second portion of the first long side portion include a first group of output electrodes and a second group of output electrodes of the plurality of output electrodes arranged in the long side direction, respectively;
a first portion and a second portion of the second long side portion include a third group of output electrodes and a fourth group of output electrodes of the plurality of output electrodes arranged in the long side direction, respectively;
a center portion between the first portion and the second portion of the second long side portion includes the plurality of power supply input electrodes arranged in the long side direction; and
a center portion between the first portion and the second portion of the first long side portion includes the plurality of display input electrodes arranged in the long side direction and the one of the space and the electrode.

9. A display device according to claim 8, wherein:
the semiconductor element comprises a plurality of output circuits for outputting, among the plurality of gradation voltages, the output gradation voltage corresponding to the display data;
a region of the plane portion between the first group of output electrodes and the third group of output electrodes includes a first group of output circuits of the plurality of output circuits, which have outputs connected to the first group of output electrodes, arranged in the long side direction;
a region of the plane portion between the second group of output electrodes and the fourth group of output electrodes includes a second group of output circuits of the plurality of output circuits, which have outputs connected to the second group of output electrodes, arranged in the long side direction;
a region of the plane portion between the first group of output circuits and the third group of output electrodes includes a third group of output circuits of the plurality of output circuits, which have outputs connected to the third group of output electrodes, arranged in the long side direction; and
a region of the plane portion between the second group of output circuits and the fourth group of output electrodes includes a fourth group of output circuits of the plurality of output circuits, which have outputs connected to the fourth group of output electrodes, arranged in the long side direction.

10. A display device according to claim 7, wherein each of the plurality of power supply input electrodes has an area of a portion which connects each of the plurality of power supply input electrodes and the first conductor wiring, which is larger than an area of a corresponding portion of each of the plurality of display input electrodes.

11. A display device according to claim 10, wherein each of the plurality of power supply input electrodes comprises a plurality of electrodes each having a dimension which is the same as a dimension of each of the plurality of display input electrodes.

12. A display device according to claim 11, wherein each of the plurality of power supply input electrodes comprises an electrode having a dimension which is larger than the dimension of each of the plurality of display input electrodes.
